(19) United States
(12) Patent Application Publication
(10) Pub. No.: US 2018/0125208 A1
(43) Pub. Date: May 10, 2018

(54) HUNTING ACCESSORY BAG DEVICE AND METHOD

(71) Applicant: John Jeffrey Peters, Frankford (CA)

(72) Inventor: John Jeffrey Peters, Frankford (CA)

(21) Appl. No.: 15/347,335

(22) Filed: Nov. 9, 2016

(51) Int. Cl. A45F 3/04; A45C 3/00; A45C 11/00; A45C 13/00; A45C 13/10; F42B 39/02; A01M 31/00

(52) U.S. Cl. CPC A45F 3/04; A45C 3/001; A45C 11/00; A45C 13/008; A45F 2003/001; F42B 39/02; A01M 31/00; A45C 2011/002; A45C 2013/1015; A45C 13/103

(57) ABSTRACT

An accessory bag includes a main storage compartment having an outer surface, an inner surface, a front side, a back side, a top portion, and a bottom portion. The accessory bag may further include a plurality of pockets attached to the front side with each pocket featuring a means for closure and storage space of at least 3 cubic inches. In addition, the accessory bag may have at least 2 carry straps attached to the top portion of the main storage compartment. The accessory bag is useful for organizing, transporting, and storing items associated with hunting, in particular the accessories required when using a boat to hunt water fowl.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of package and article carriers and more specifically relates to accessory bags.

### 2. Description of Related Art

A carryall bag is a large bag made of cloth or leather typically with a rectangular base and a zippered opening at the top. Two handles enable the bag to be carried, and a (usually removable) strap lets the user support the bag on the shoulders. Carryall bags are produced in a wide variety of applications and sizes, but are not fit to transport and store larger items in outdoor climates. A suitable solution is desired.

U.S. Pat. No. 6,345,744 to Eldridge relates to a Duck Hunter's Caddy. The described Duck Hunter's Caddy includes a floating caddy for holding and storing the gear of wading hunters comprising an inflatable tube formed from an impermeable fabric for providing flotation for the caddy. The tube is configured to create a water resistant storage compartment within its periphery. The top of the storage compartment has weather resistant zipper for access into the storage compartment. The caddy is fitted with straps for attaching a shotgun and shoulder straps mounted to the tube to allow the caddy to be carried on the back of the hunter in knapsack fashion. The caddy may be floated in and out of a flooded area by a wading hunter by means of a tether attached to the tube. The fabric forming the caddy maybe printed in a desired camouflage pattern.

### BRIEF SUMMARY OF THE INVENTION

In view of the foregoing disadvantages inherent in the known accessory bag art, the present disclosure provides a novel hunting accessory bag device. The general purpose of the present disclosure, which will be described subsequently in greater detail, is to provide a hunting accessory bag device.

An accessory bag is disclosed herein. The accessory bag includes a main storage compartment having an outer surface, an inner surface, a front side, a back side, a top portion, and a bottom portion. The accessory bag may further include a plurality of pockets attached to the front side with each pocket featuring a means for closure and storage space of at least 3 cubic inches. In addition, the accessory bag may have at least 2 carry straps attached to the top portion of the main storage compartment.

A method of using the accessory bag is also disclosed herein. The method of using the accessory device bag includes the steps of opening the main storage compartment and pockets of the accessory bag, loading the device with items and equipment, carrying the accessory bag to an intended location, placing the accessory bag in front of the user, opening the main storage compartment and pockets of the accessory bag for access to desired items and equipment, reclosing the main storage compartment and pockets of the accessory bag.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a hunting accessory bag device, constructed and operative according to the teachings of the present disclosure.

FIG. 1 is a perspective view of a hunting boat featuring a hunting accessory bag device during an ‘in-use’ condition, according to an embodiment of the disclosure.

FIG. 2 is a front view of the accessory bag device of FIG. 1, according to an embodiment of the present disclosure showing a boat oar being loaded into the accessory bag device. FIG. 2 also details the plurality of pockets available for accessory storage and the carry straps attached to the top of the device.

FIG. 3 is an additional front view of the accessory bag device of FIG. 1, according to an embodiment of the present disclosure detailing the material design, general layout, and pocket features of the accessory bag device. In addition, a few of the closures and protective flaps are also shown.

FIG. 4 is a detailed view of a pair of pockets featured on the accessory bag device of FIG. 1, according to an embodiment of the present disclosure. This figure demonstrates some of the storage capabilities of the accessory bag device and means of closure available for securing personal items inside of the pockets.

FIG. 5 is a flow diagram illustrating a method of use for an accessory bag device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an accessory bag and more particularly to a hunting accessory bag device as used to improve the storage and transportation of accessories in a portable bag.

Generally, there are many tools and accessories that may be required in order to complete a successful hunting expedition. When targeting water fowl, a hunter must pack up a set of oars for the watercraft in addition to shotguns, rifles, ammunition, supplies, and personal items. As a result, many hunters decide to store their oars onboard the watercraft which causes them to quickly deteriorate from the weather. The hunting accessory bag device changes the boat oars from a thing taking up space in the boat and getting in the way while the hunter hunts, into a very useful tool to use while hunting water fowl from the boat.

The hunting accessory bag device features a zippered, waterproof bag that protects oars and other items from the weather both during and after the hunt. The device very simply lays across the deck or seat in front of the hunter on the boat. The device features slots for at least 6 gun shells along with zippered pockets to keep items such as cell phones, ammunition, and game calls neatly stored and organized in front of the hunter awaiting use. Many boat oars are constructed from materials that are shiny or reflect sunlight from a distance. The difference between a successful hunt and unsuccessful hunt often depends on how well the hunter and his boat has been hidden along the shore line. This device includes a protective layering with camouflage design that will keep important items protected from environmental elements while remaining undetectable by targeted game.

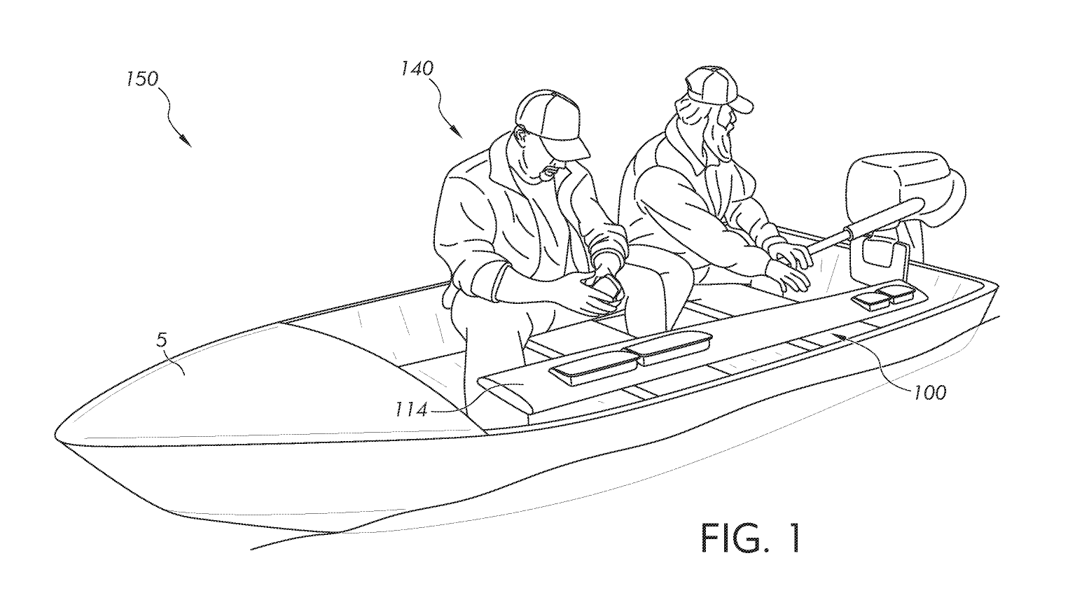

Referring now more specifically to the drawings by numerals of reference, there is shown in FIGS. 1-4, various views of an accessory bag 100. FIG. 1 shows an accessory bag 100 during an ‘in-use’ condition 150, according to an embodiment of the present disclosure. Here, the accessory bag 100 may be beneficial for use by a user 140 to store and transport accessories in a portable bag. As illustrated, the accessory bag 100 may include a back side 114 that is configured to lay flat on a surface 5.

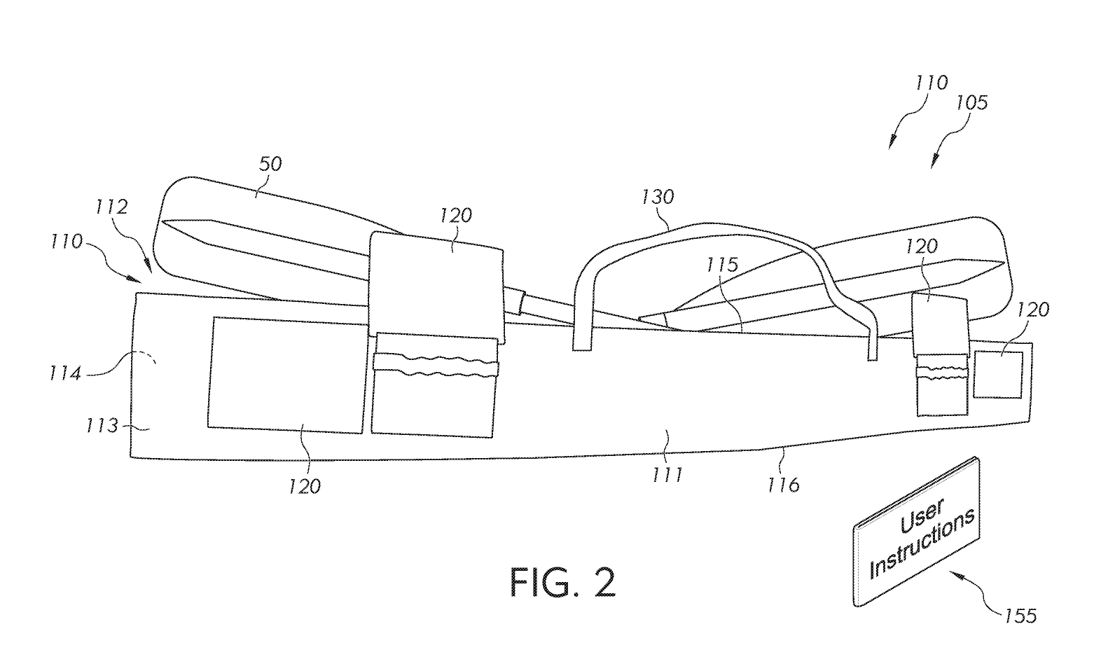

FIG. 2 shows the accessory bag 100 of FIG. 1. According to one embodiment, the accessory bag 100 may be arranged as a kit 105. In particular, the accessory bag 100 may further include a set of instructions 155. The instructions 155 may detail functional relationships in relation to the structure of the accessory bag 100 (such that the accessory bag 100 can be used, maintained, or the like, in a preferred manner). As above, the accessory bag 100 may include a main storage compartment 110 having an outer surface 111, an inner surface 112 configured to contain boat oars 50, a front side 113, a back side 114, a top portion 115, and a bottom portion 116. The accessory bag may further include a plurality of pockets 120 attached to the front side 113. In addition, the accessory bag may have at least 2 carry straps 130 attached to the top portion 115 of the main storage compartment 110.

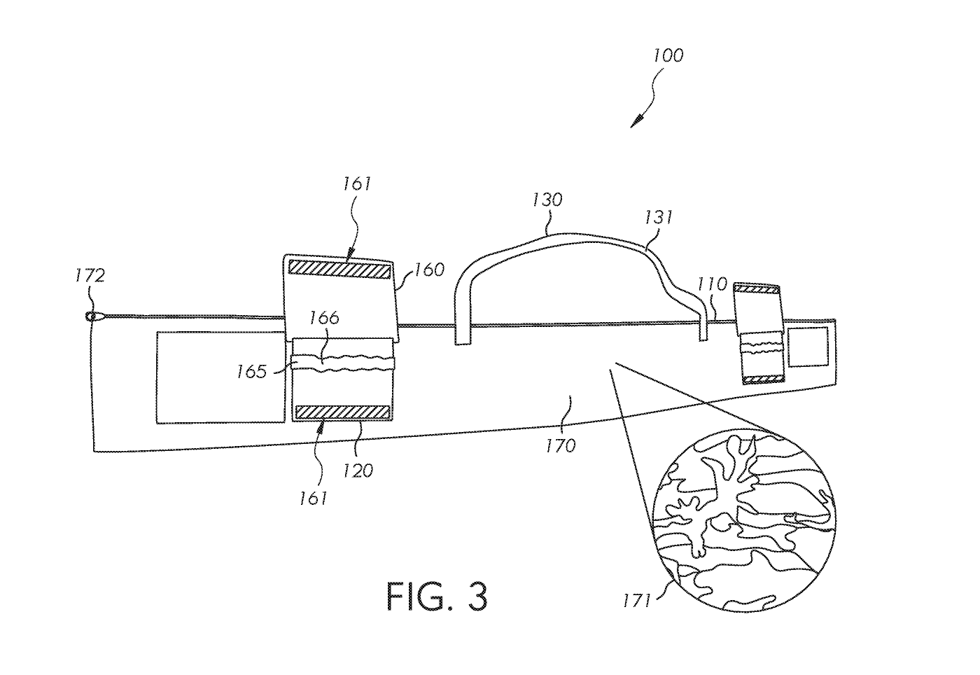

FIG. 3 is a front view of the accessory bag 100 of FIG. 1, according to an embodiment of the present disclosure. The accessory bag 100 may include a zipping fastener 172 for securing closure of the main storage compartment 110. The accessory bag 100 may further feature pockets 120 having a flap 160 with a hook and loop closure 161 for providing additional protection to items contained therein. A loop storage assembly 165 constructed from durable elastic materials 166 may be attached to the exterior of a pocket 120, but beneath the flap 160 for securing additional accessories. Carry straps 130 measuring at least 18 inches in length 131 may be fixed to the accessory bag 100 providing the added convenience of allowing the accessory bag 100 to be transported by hand or over a shoulder similar to a backpack. In addition, the accessory bag 100 may be constructed from a waterproof material 170 having a camouflage color pattern 171 that helps keep stored items protected from harmful environmental elements without alerting the surroundings to its presence.

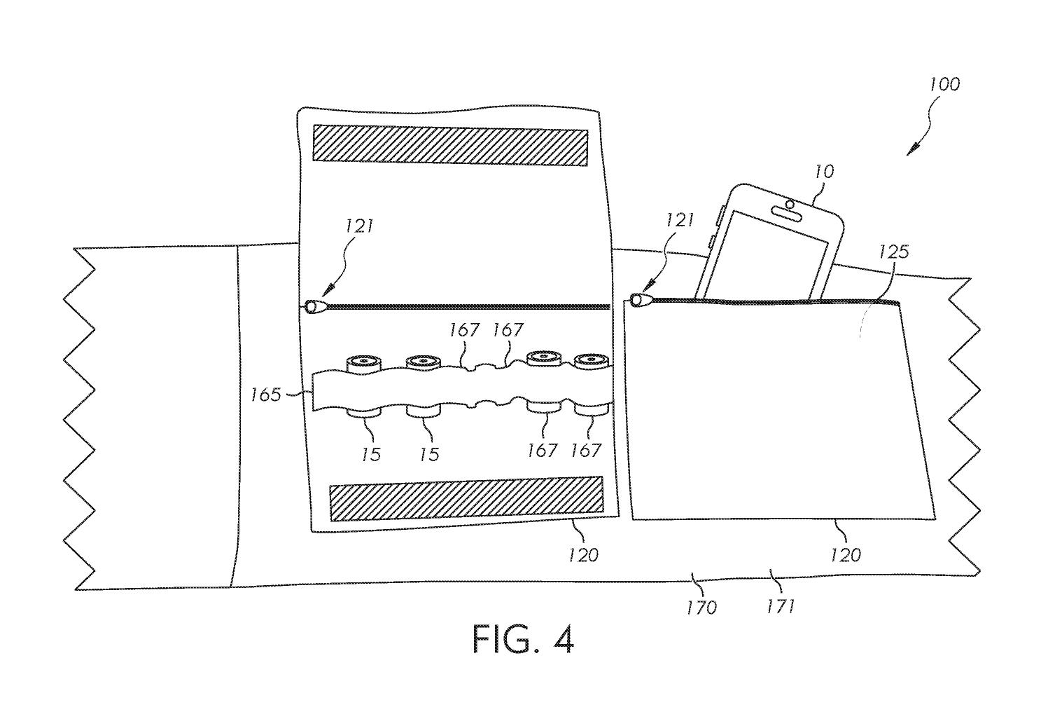

FIG. 4 is a detailed view of the accessory bag 100 of FIG. 1, according to an embodiment of the present disclosure. The accessory bag 100 may feature pockets 120 including at least one loop storage assembly 165 with slots 167 useful for securing shotgun shells 15. The pockets 120 featured on the accessory bag 100 may include at least 3 cubic inches of storage space 125 and a means for closure 121 that may be used to removably retain at least one personal item 10 therein. The accessory bag 100 and pockets may be constructed from a waterproof material 170 having a camouflage color pattern 171 allowing the items contained to be protected from harmful environmental elements.

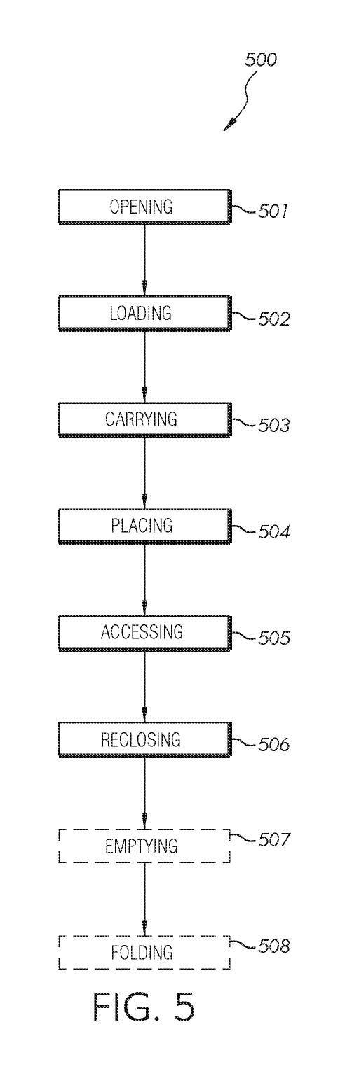

FIG. 5 is a flow diagram illustrating a method of use for the accessory bag 100, according to an embodiment of the present disclosure. In particular, the method of using 500 may include one or more components or features of the accessory bag 100 as described above. As illustrated, the method of using 500 may include the steps of: step one 501, opening the main storage compartment 110 and pockets 120 of the accessory bag 100; step two 502, loading the main storage compartment 110 and pockets 120 of the accessory bag 100 with personal items 10 and equipment; step three 503, carrying the accessory bag 100 to an intended location; step four 504, placing the accessory bag 100 in front of the user 140; step five 505, accessing the main storage compartment 110 and pockets 120 of the accessory bag 100; and step six 506, reclosing the main storage compartment 110 and pockets 120 of the accessory bag 100.

It should be noted that step seven 507, emptying the contents of the accessory bag 100; and step eight 508, folding the accessory bag 100 for convenient storage are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using the accessory bag (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An accessory bag, the device comprising:
a main storage compartment having an outer surface, an inner surface, a front side, a back side, a top portion, and a bottom portion;
a plurality of pockets attached to said front side, said pockets including
a means for closure,
storage space of at least 3 cubic inches; and
at least 2 carry straps attached to said top portion of said main storage compartment.

2. The accessory bag of claim 1, wherein said main storage compartment is dimensionally configured to contain boat oars.

3. The accessory bag of claim 1, wherein said outer surface is constructed of a waterproof material.

4. The accessory bag of claim 1, wherein said outer surface has a functional camouflage color pattern.

5. The accessory bag of claim 1, wherein said back side is configured to lay flat on a surface.

6. The accessory bag of claim 3, wherein said waterproof material is foldable for compact storage.

7. The accessory bag of claim 2, wherein said main storage compartment is further structurally sealed by a zipping fastener.

8. The accessory bag of claim 1, wherein said pockets include said means of closure that prohibits environmental elements from contacting items retained in said pockets.

9. The accessory bag of claim 8, wherein at least one of the pockets is configured to removably retain at least one personal item selected from the group consisting of a cell phone, wallet, and waterfowl call.

10. The accessory bag of claim 8, wherein said at least one of the pockets features a loop storage assembly fixed to the exterior of said pocket.

11. The accessory bag of claim 10, wherein said loop storage assembly is constructed from durable elastic materials configured to expand and hold an object in place.

12. The accessory bag of claim 10, wherein said loop storage assembly features at least 4 slots configured to frictionally secure a standard shotgun shell.

13. The accessory bag of claim 10, wherein said pocket features a flap including hook and loop closure that is configured to removably cover said loop storage assembly.

14. The accessory bag of claim 1, wherein at least one of said carry straps is fixed to said front side.

15. The accessory bag of claim 1, wherein at least one of said carry straps is fixed to said back side.

16. The accessory bag of claim 1, wherein said carry straps measure at least 18 inches in length for convenient carrying by hand or by shoulder.

17. An accessory bag, the device comprising:
a main storage compartment having an outer surface, an inner surface, a front side, a back side, a top portion, and a bottom portion;
a plurality of pockets attached to said front side, said pockets including
a means for closure,
storage space of at least 3 cubic inches;
at least 2 carry straps attached to said top portion of said main storage compartment.
wherein said main storage compartment is dimensionally configured to contain boat oars;
wherein said outer surface is constructed of a waterproof material;
wherein said outer surface has a functional camouflage color pattern;
wherein said back side is configured to lay flat on a surface;
wherein said waterproof material is foldable for compact storage;
wherein said main storage compartment is further structurally sealed by a zipping fastener;
wherein said pockets include said means of closure that prohibits environmental elements from contacting items retained in said pockets;
wherein said at least one of the pockets features a loop storage assembly fixed to the exterior of said pocket;
wherein said loop storage assembly is constructed from durable elastic materials configured to expand and hold an object in place;
wherein said loop storage assembly features at least 4 slots configured to each frictionally secure a standard shotgun shell;
wherein said pocket features a flap including hook and loop closure that is configured to removably cover said loop storage assembly;
wherein at least one of said carry straps is fixed to said front side;
wherein at least one of said carry straps is fixed to said back side; and
wherein said carry straps measure at least 18 inches in length for convenient carrying by hand or by shoulder.

18. The accessory bag of claim 17, further comprising set of instructions; and
wherein the device is arranged as a kit.

19. A method of using the accessory bag of claim 17, the method comprising the steps of:
opening the main storage compartment and pockets of the accessory bag;
loading the main storage compartment and pockets of the accessory bag with personal items and equipment;
carrying the accessory bag to an intended location;
placing the accessory bag in front of the user;
accessing the main storage compartment and pockets of the accessory bag; and
reclosing the main storage compartment and pockets of the accessory bag.

20. The method of claim 19, further comprising the steps of:
emptying the contents of the accessory bag; and
folding the accessory bag for convenient storage.
